(19) United States
(12) Patent Application Publication
(10) Pub. No.: US 2024/0025197 A1
(43) Pub. Date: Jan. 25, 2024

(54) THERMAL TRANSFER RECORDING SHEET

(71) Applicant: CANON KABUSHIKI KAISHA, Tokyo (JP)

(72) Inventors: TAICHI SHINTOU, Saitama (JP); KOROMO SHIROTA, Kanagawa (JP); TSUYOSHI SANTO, Kanagawa (JP)

(21) Appl. No.: 18/353,245

(22) Filed: Jul. 17, 2023

(30) Foreign Application Priority Data
Jul. 20, 2022 (JP) 2022-115657
May 2, 2023 (JP) 2023-076113

(51) Int. Cl. B41M 5/382; C08K 5/353; C09B 23/14; C08K 5/47; C08K 5/3432; C09B 46/00; C08K 5/3472; C09B 57/00

(52) U.S. Cl. CPC B41M 5/38228; C08K 5/353; C09B 23/145; C08K 5/47; C08K 5/3432; C09B 46/00; C08K 5/3472; C09B 57/00

(57) ABSTRACT

A thermal transfer recording sheet includes a substrate, a yellow coloring material layer, a magenta coloring material layer, a cyan coloring material layer, and a protective layer. The yellow coloring material layer, the magenta coloring material layer, the cyan coloring material layer, and the protective layer are frame-sequentially arranged over the substrate. The protective layer contains a compound represented by formula (1):

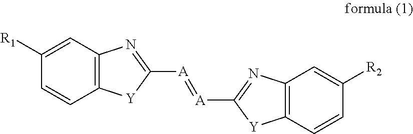

where each A is independently ═CH— or ═CH—C₆H₄—, each Y is independently an oxygen atom or a sulfur atom, and R₁ and R₂ are each independently a hydrogen atom or an alkyl group having 1 to 4 carbon atoms.

### BACKGROUND OF THE INVENTION

### Field of the Invention

The present disclosure relates to a thermal transfer recording sheet.

### Description of the Related Art

The proliferation of high-definition, high-image-quality portable color display devices, such as those with 4K and 8K resolutions, has led to an increased demand for convenient color printing of photographs and documents taken or produced with these devices. Examples of a color printing method corresponding to these include an electrophotographic method, an inkjet method, and a thermal transfer recording method. Among these methods, the thermal transfer recording method is excellent as a method capable of easily performing printing regardless of the surrounding environment because printing can be performed by a dry process and the printer is compact and excellent in portability. In addition, there is a demand for a thermal transfer recording printer intended for portable use.

In the thermal transfer recording method, since yellow, magenta, and cyan are recorded in an overlapping manner, catalyst fading is known to occur between dyes when they are mixed. Even if a dye with high lightfastness is used in a single color, catalytic fading occurs because of the difference in lightfastness between colors when the colors are mixed. For this reason, depending on the environment in which an image is stored, the color balance may be disrupted to give a visually degraded impression, and there may be a disadvantage in terms of the durability of the image.

Many studies have been conducted to prevent catalytic fading between dyes in a thermal transfer sheet used in a thermal transfer recording method. For example, Japanese Patent Laid-Open No. 4-085080 discloses a technique in which a fluorescent brightening agent is contained in a coloring material layer. Japanese Patent Laid-Open No. 2001-158879 discloses a technique of incorporating an anti-fading agent.

Depending on the environment in which an image is stored, the color balance may be disrupted to give a visually degraded impression, and there may be a disadvantage in terms of the durability of the image.

In Japanese Patent Laid-Open Nos. 4-085080 and 2001-158879, prevention of catalytic fading between dyes has been studied. However, there is no mention of the durability of the image in terms of color balance. There has been a demand for the development of a thermal transfer recording sheet with an improved color balance.

### SUMMARY OF THE INVENTION

The present disclosure provides a thermal transfer recording sheet capable of obtaining an image that is less likely to lose its color balance even when the image is stored for a long period of time.

A thermal transfer recording sheet according to an embodiment of the present disclosure includes a substrate, a yellow coloring material layer, a magenta coloring material layer, a cyan coloring material layer, and a protective layer, in which the yellow coloring material layer, the magenta coloring material layer, the cyan coloring material layer, and the protective layer are frame-sequentially arranged over the substrate, and the protective layer contains a compound represented by formula (1).

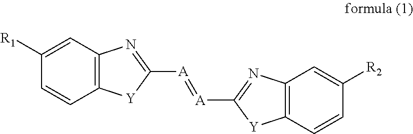

where in formula (1), each A is independently ═CH— or ═CH—C₆H₄—,
each Y is independently an oxygen atom or a sulfur atom, and
R₁ and R₂ are each independently a hydrogen atom or an alkyl group having 1 to 4 carbon atoms.

Further features of the present disclosure will become apparent from the following description of exemplary embodiments.

### DESCRIPTION OF THE EMBODIMENTS

Embodiments of the present disclosure will be described in detail below.

### Features of the Present Disclosure

The inventors have conducted intensive studies to address the above disadvantages and have found that by using the following thermal transfer recording sheet, it is possible to provide a thermal transfer recording sheet that can produce an image that is less likely to lose its color balance even when the image is stored for a long period of time.

A thermal transfer recording sheet according to an embodiment of the present disclosure includes at least a substrate, and over the substrate, a yellow coloring material layer, a magenta coloring material layer, a cyan coloring material layer, and a protective layer. The protective layer contains at least one compound represented by formula (1). Each of the coloring material layers contains a coloring material corresponding to that layer. The yellow coloring material layer can contain a compound selected from the group of compounds represented by the following formula (2). The magenta coloring material layer can contain a compound selected from the group of compounds represented by the following formula (3). The cyan coloring material layer can contain a compound selected from the group of compounds represented by the following formula (4).

Although the mechanism by which the effect is provided through the incorporation of the compound represented by the above formula (1) in the protective layer is not yet fully understood, we speculate as described below.

To form a color image, the mixing ratios of yellow, magenta, and cyan are different. Typically, after forming the image composed of the coloring material layers, a protective layer is formed to protect the image surface. In an embodiment of the present disclosure, since the protective layer contains the compound represented by formula (1), the entire formed image can be covered under uniform conditions. Thus, the image is less likely to lose its color balance. If the compound represented by formula (1) is contained in each coloring material layer, the compound is present in different amounts in different portions when a color image is formed. Thus, the image tends to lose its color balance.

### Configuration of Thermal Transfer Recording Sheet

The configuration of a thermal transfer recording sheet will be described in detail below.

### (I-1) Substrate

The substrate included in the thermal transfer recording sheet supports at least the three types of coloring material layers. The substrate is not limited to a particular substrate. Any substrate that has appropriate heat resistance and strength and that is known in the field of a thermal transfer recording sheet can be used.

Examples of the substrate include poly(ethylene terephthalate) films, poly(ethylene naphthalate) films, polycarbonate films, polyimide films, polyamide films, aramid films, polystyrene films, poly(1,4-cyclohexylenedimethylene terephthalate) films, polysulfone films, polypropylene films, poly(phenylene sulfide) films, poly(vinyl alcohol) films, cellophane films, cellulose derivative films, polyethylene films, poly(vinyl chloride) films, nylon films, capacitor paper, and paraffin paper. Among these, a poly(ethylene terephthalate) film can be used as the substrate from the viewpoint of mechanical strength, solvent resistance, and economy.

### Thickness of Substrate

The thickness of the substrate can be 0.5 μm or more and 50 μm or less, and can be 3 μm or more and 10 μm or less from the viewpoint of transferability.

### Adhesion Treatment

When a composition (ink) containing a dye is applied onto the substrate in order to form each of the coloring material layer, a coating liquid (dye composition) may have insufficient wettability, adhesiveness, etc. Thus, a surface of the substrate to be coated can be subjected to adhesion treatment, if necessary.

The adhesion treatment is not limited to a particular one. Any method known in the field of thermal transfer recording sheets can be used. Examples of the adhesion treatment include ozone treatment, corona discharge treatment, ultraviolet treatment, plasma treatment, low-temperature plasma treatment, primer treatment, and chemical treatment. Two or more of these treatments may be performed in combination.

For the adhesion treatment of the substrate, a method for forming an adhesive layer on the substrate by application may be used. The adhesive layer is not limited to a particular one, and any adhesive layer known in the field of thermal transfer recording sheets can be used. Examples of a material used for the adhesive layer include organic materials, such as polyester resins, polystyrene resins, polyacrylate resins, polyamide resins, polyether resins, poly(vinyl acetate) resins, polyethylene resins, polypropylene resins, poly(vinyl chloride) resins, poly(vinyl alcohol) resins, and poly(vinyl butyral) resins; and fine inorganic particles of, for example, silica, alumina, magnesium carbonate, magnesium oxide, and titanium oxide.

### Heat-Resistant Slipping Layer

For the purpose of improving the heat resistance and the running properties of a thermal head, a heat-resistant slipping layer can be disposed on a surface of the substrate opposite to the surface on which the coloring material layers are disposed.

The heat-resistant slipping layer is formed of a layer containing a heat-resistant resin. The heat-resistant resin is not limited to a particular resin. For example, the following resins can be used. That is, examples thereof include poly(vinyl butyral) resins, poly(vinyl acetal) resins, polyester resins, polyether resins, polybutadiene resins, vinyl chloride-vinyl acetate copolymer resins, styrene-butadiene copolymer resins, poly(urethane acrylate), poly(ester acrylate), polyimide resins, polycarbonate resins.

The heat-resistant slipping layer may contain additives, such as a crosslinking agent, a release agent, a lubricant, and a slip additive. Examples of the lubricant include amino-modified silicone compounds and carboxy-modified silicone compounds. Examples of the slip additive include fine particles, such as heat-resistant fine silica particles.

The heat-resistant slipping layer can be formed by adding the above-described heat-resistant resin, additives, and so forth to a solvent, dissolving or dispersing them to prepare a heat-resistant slipping layer coating liquid, applying the heat-resistant slipping layer coating liquid to a substrate, and drying the coating liquid. The heat-resistant slipping layer coating liquid may be applied by any method, for example, by using a bar coater, a gravure coater, a reverse roll coater, a rod coater, or an air doctor coater. The thickness can be easily adjusted by a coating method using a gravure coater.

The amount of heat-resistant slipping layer coating liquid applied to the substrate can be such that the thickness of the heat-resistant slipping layer after drying is 0.1 μm or more and 5 μm or less in terms of transferability.

### (I-2) Protective Layer

The protective layer in the thermal transfer recording sheet according to an embodiment of the present disclosure is formed of a layer containing at least one compound selected from the group of compounds represented by formula (1).

The thermal transfer recording sheet may include one or two transferable protective layers for protecting an image surface after image formation, the one or two transferable protective layers and the coloring material layers being frame-sequentially arranged over the substrate. Each protective layer can also be disposed over a sheet (substrate) different from the sheet over which the coloring material layers are arranged. In this case, the thermal transfer recording sheet according to an embodiment of the present disclosure includes a sheet having a substrate and the coloring material layers (coloring material layer sheet) and a sheet having a substrate and the protective layer (protective layer sheet).

The protective layer can be formed by applying a composition for the protective layer to the substrate and drying the composition. Non-limiting examples of a method for applying the composition for the protective layer over the substrate include methods using a bar coater, a gravure coater, a reverse roll coater, a rod coater, an air doctor coater, etc. The thickness can be easily adjusted by a coating method using a gravure coater.

The drying conditions after applying the composition for the protective layer are not limited to particular conditions as long as sufficient drying can be performed. For example, drying can be performed at 50° C. to 120° C. for 1 second to 5 minutes.

A compound represented by formula (1) will be described:

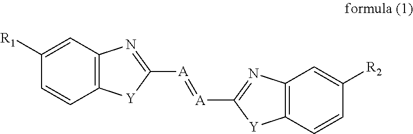

where in formula (1),
each A is independently ═CH— or ═CH—C₆H₄—, each Y is independently an oxygen atom or a sulfur atom, and R₁ and R₂ are each independently a hydrogen atom or an alkyl group having 1 to 4 carbon atoms.

Non-limiting examples of the alkyl groups for R₁ and R₂ in formula (1) include linear or branched alkyl groups each having 1 to 4 carbon atoms. Specific examples thereof include a methyl group, an ethyl group, a n-propyl group, an isopropyl group, a n-butyl group, an isobutyl group, and a tert-butyl group. Among these, a methyl group and an ethyl group can be used, and a methyl group can be particularly used, because an image that is less likely to lose its color balance even when the image is stored for a long period of time is easily obtained.

The compound represented by formula (1) according to an embodiment of the present disclosure can be purchased as a commercial product. The compound includes cis-trans structural isomers, any of which is within the scope of the present disclosure, and the compound may be a mixture thereof.

Examples of the compound that can be used are compounds (1-1) to (1-12), illustrated below, each having a trans configuration, but the present disclosure is not limited thereto.

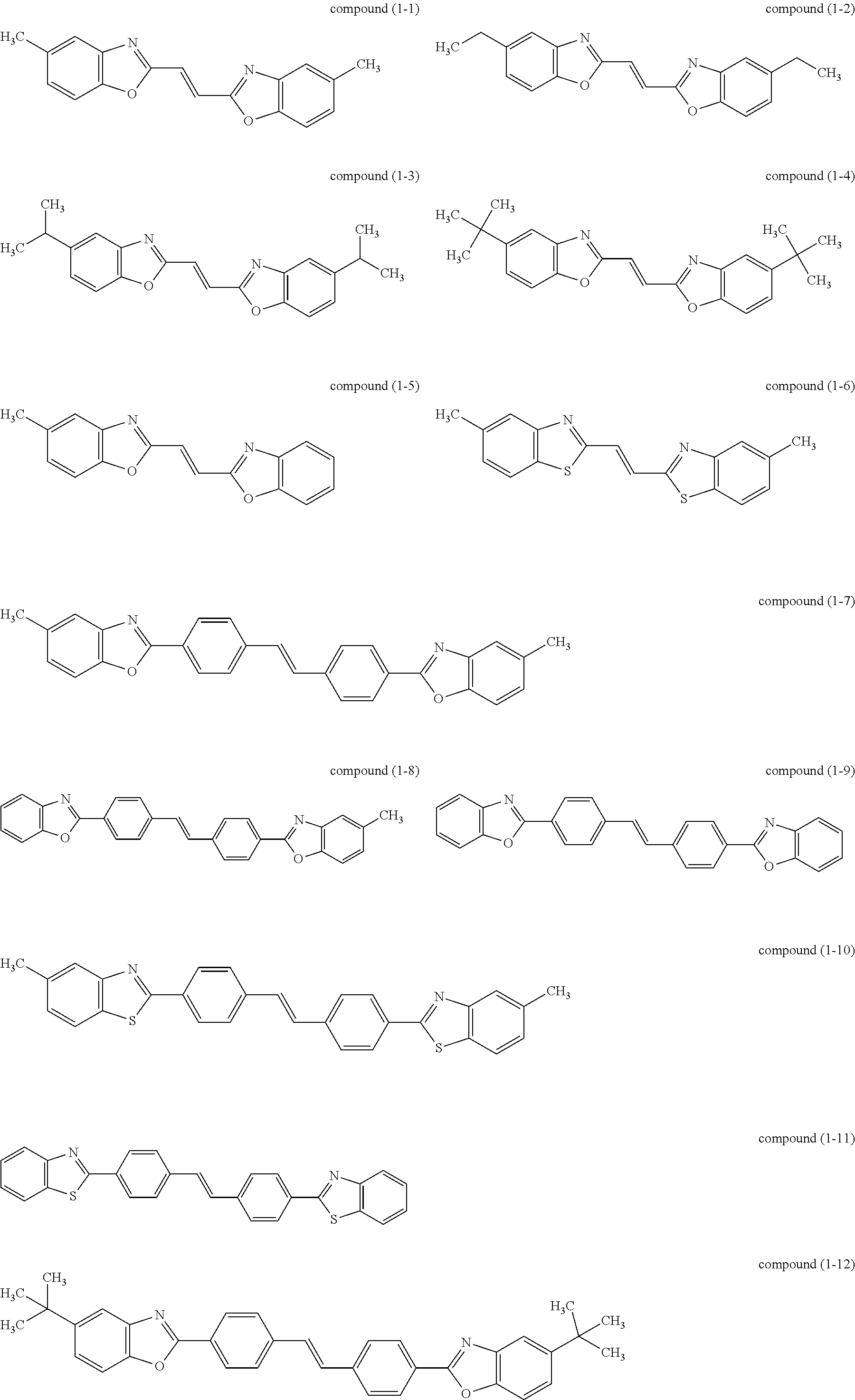

A binder resin used in the protective layer according to an embodiment of the present disclosure is not limited to a particular binder resin. Examples of a binder resin that can be used include acrylic resins, such as polystyrene, poly(methyl methacrylate), and poly(ethyl acrylate), styrenic resins, such as poly-α-methylstyrene, vinyl resins, such as poly(vinyl chloride), poly(vinyl acetate), vinyl chloride-vinyl acetate copolymers, poly(vinyl butyral), and poly(vinyl acetal), and synthetic resins, such as polyamide resins, epoxy resins, polyurethane resins, petroleum resins, ionomers, ethylene-acrylic acid copolymers, and ethylene-acrylic ester copolymers.

The amount of compound represented by formula (1) used in an embodiment of the present disclosure is preferably 0.1 parts by mass or more and 50 parts by mass or less, more preferably 0.5 parts by mass or more and 20 parts by mass or less, based on 100 parts by mass of the binder resin because it is easy to obtain an image that is less likely to lose its color balance even when the image is stored for a long period of time.

The thickness of the protective layer of the present disclosure can be about 0.1 μm or more and about 5 μm or less.

To facilitate peeling from the sheet, a release layer containing an acrylic resin, such as poly(methyl methacrylate) or poly(ethyl acrylate) and having a thickness of about 0.1 μm or more and about 1.5 μm or less can be provided below the protective layer containing the compound. The release layer is formed over the substrate described above.

### (I-3) Coloring Material Layer

The thermal transfer recording sheet includes at least three types of coloring material layers including the yellow coloring material layer, the magenta coloring material layer, and the cyan coloring material layer in a frame-sequential manner. At least one of a compound represented by formula (2) as a yellow coloring material, a compound represented by formula (3) as a magenta coloring material, and a compound represented by formula (4) as a cyan coloring material can be contained.

### (I-3-2) Component Contained in Coloring Material Layer

Components contained in the coloring material layer will be described below.

### (i) Coloring Material Compound

A coloring material compound contained in the coloring material layer of each color is not limited to a single type. Any coloring material compound can be used as long as it is a dye known for thermal transfer in the field of thermal transfer recording sheets and is thermally transferable. The coloring material compound can be used in combination with the coloring materials described above.

The melting point of each of the compounds represented by formulae (2) to (4) is preferably 40° C. to 200° C., more preferably 50° C. to 180° C., still more preferably 60° C. to 150° C., from the viewpoint of transferability and storage stability.

### Formula (2)

The compound (yellow dye) represented by formula (2) is described below:

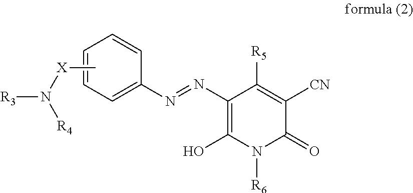

where in formula (2),
X is a carbonyl group or a sulfonyl group,
R₃ and R₄ are each independently a linear alkyl group having 1 to 12 carbon atoms, a branched alkyl group having 3 to 12 carbon atoms, or a cycloalkyl group having 3 to 12 carbon atoms,
R₅ is a linear or branched alkyl group having 1 to 12 carbon atoms,
R₆ is a hydrogen atom, an alkyl group, an aryl group, a benzyl group, or —NR₇R₈, and
R₇ and R₈ are each independently a hydrogen atom, an unsubstituted alkyl group, an alkyl group having a substituent, an unsubstituted aryl group, an aryl group having a substituent, an unsubstituted acyl group, or an acyl group having a substituent, or R₇ and R₈ are optionally taken together to form a ring structure.

Non-limiting examples of the linear alkyl group having 1 to 12 carbon atoms, the branched alkyl group having 3 to 12 carbon atoms, and the cycloalkyl groups having 3 to 12 carbon atoms for R₃ and R₄ in formula (2) include a methyl group, an ethyl group, a n-propyl group, an isopropyl group, a n-butyl group, a sec-butyl group, a tert-butyl group, a n-hexyl group, a n-heptyl group, a n-octyl group, a n-nonyl group, a n-decyl group, a n-undecyl group, a n-dodecyl group, a 2-ethylhexyl group, and a cyclohexyl group. Among these, an alkyl group having 8 carbon atoms can be used, and a branched alkyl group, such as a 2-ethylhexyl group, can be particularly used, because it is easy to obtain an image that is less likely to lose its color balance even when the image is stored for a long period of time.

Non-limiting examples of the alkyl group for R₅ in formula (2) include linear or branched alkyl groups each having 1 to 12 carbon atoms. Specific examples thereof include a methyl group, an ethyl group, a n-propyl group, an isopropyl group, a n-butyl group, an isobutyl group, a 2-methylbutyl group, 2,3,3-trimethylbutyl group, and an octyl group. Among these, a methyl group, an ethyl group, a propyl group, a n-butyl group, a 2-methylbutyl group, and a 2,3,3-trimethylbutyl group can be used, and a methyl group can be particularly used, because it is easy to obtain an image that is less likely to lose its color balance even when the image is stored for a long period of time.

Non-limiting examples of the alkyl group for R₆ in formula (2) include linear or branched alkyl groups each having 1 to 12 carbon atoms. Specific examples thereof include a methyl group, an ethyl group, a n-propyl group, an isopropyl group, a n-butyl group, an isobutyl group, 2-methylbutyl group, a 2,3,3-trimethylbutyl group, and an octyl group. Among these, a linear or branched alkyl group having 1 to 4 carbon atoms can be used, and a linear alkyl group, such as a methyl group, an ethyl group, a propyl group, or a n-butyl group, can be particularly used, because it is easy to obtain an image that is less likely to lose its color balance even when the image is stored for a long period of time.

In formula (2), when R₆ is —NR₇R₈, R₇ and R₈ are each an unsubstituted alkyl group, an alkyl group having a substituent, an unsubstituted aryl group, an aryl group having a substituent, an unsubstituted acyl group, or an acyl group having a substituent.

Non-limiting examples of the alkyl group for each of R₇ and R₈ include substituted or unsubstituted alkyl groups each having 1 to 20 carbon atoms. When a substituent is contained, the number of carbon atoms includes the number of carbon atoms of the substituent. Specific examples of the unsubstituted alkyl group include linear, branched, or cyclic alkyl groups, such as a methyl group, an ethyl group, a n-propyl group, an isopropyl group, a n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, and a 2-ethylhexyl group. An example of a substituent in the substituted alkyl group is a cyclohexenyl group. Among these, an alkyl group having 1 to 4 carbon atoms can be used, and a methyl group can be particularly used.

Non-limiting examples of the aryl group for each of R₇ and R₈ include substituted or unsubstituted aryl groups each having 6 to 10 carbon atoms. Examples of the substituent include alkyl groups and alkoxy groups. When a substituent is contained, the number of carbon atoms includes the number of carbon atoms of the substituent. One or more substituents may be used. The substituted or unsubstituted aryl group having 6 to 10 carbon atoms can be, for example, a phenyl group, a 4-methylphenyl group, or a 4-methoxyphenyl group because it is easy to obtain an image that is less likely to lose its color balance even when the image is stored for a long period of time.

Non-limiting examples of the acyl group for each of R₇ and R₈ include substituted or unsubstituted acyl groups each having 1 to 30 carbon atoms. When a substituent is contained, the number of carbon atoms includes the number of carbon atoms of the substituent. Specific examples thereof include a formyl group; substituted or unsubstituted alkylcarbonyl groups each having 2 to 30 carbon atoms, such as an acetyl group, a propionyl group, and a pivaloyl group; substituted or unsubstituted arylcarbonyl groups each having 7 to 30 carbon atoms, such as a benzoyl group and a naphthoyl group; and a heterocyclic carbonyl groups, such as a 2-pyridylcarbonyl group and a 2-furylcarbonyl group. Among these, an acetyl group, a pivaloyl group, or a benzoyl group can be used, and an acetyl group or a benzoyl group can be particularly used, because it is easy to obtain an image that is less likely to lose its color balance even when the image is stored for a long period of time.

Non-limiting examples of the ring formed by taking R₇ and R₈ together include a pyridine ring, a piperazine ring, a morpholine ring, and a phthalimide ring.

The compound represented by formula (2) according to an embodiment of the present disclosure can be synthesized with reference to a known method described in International Publication No. WO08/114886. The compound includes azo-hydrazo tautomers, any of which is within the scope according to an embodiment of the present disclosure, and the compound may be a mixture thereof.

Examples of the compound that can be used are the following compounds (2-1) to (2-15) each illustrated in the form of an azo structure, but the present disclosure is not limited thereto.

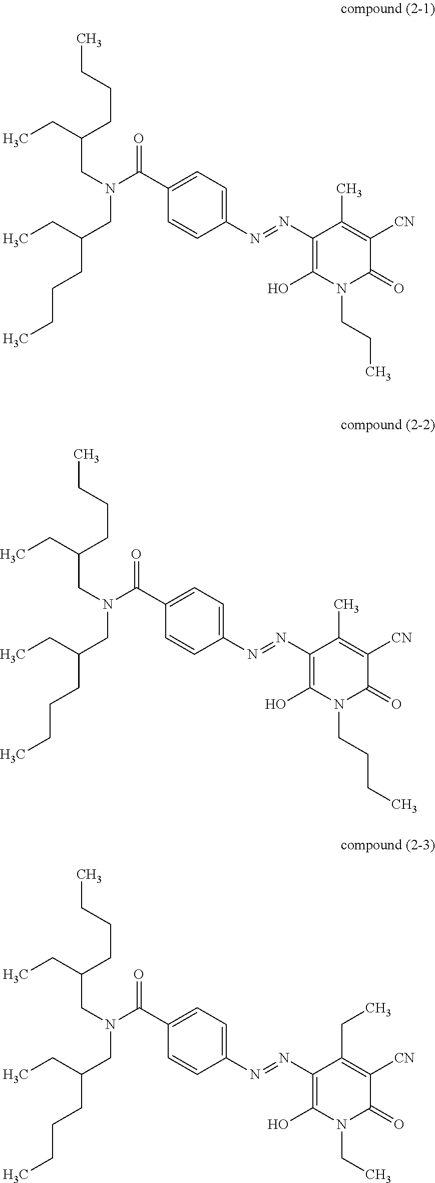 [SMILES: CCCCC(CC)CN(CC(CC)CCCC)C(=O)c1ccc(/N=N/c2c(C)c(C#N)c(=O)n(CCC)c2O)cc1 ; CCCCC(CC)CN(CC(CC)CCCC)C(=O)c1ccc(/N=N/c2c(C)c(C#N)c(=O)n(CCCC)c2O)cc1 ; CCCCC(CC)CN(CC(CC)CCCC)C(=O)c1ccc(/N=N/c2c(CC)c(C#N)c(=O)n(CC)c2O)cc1]

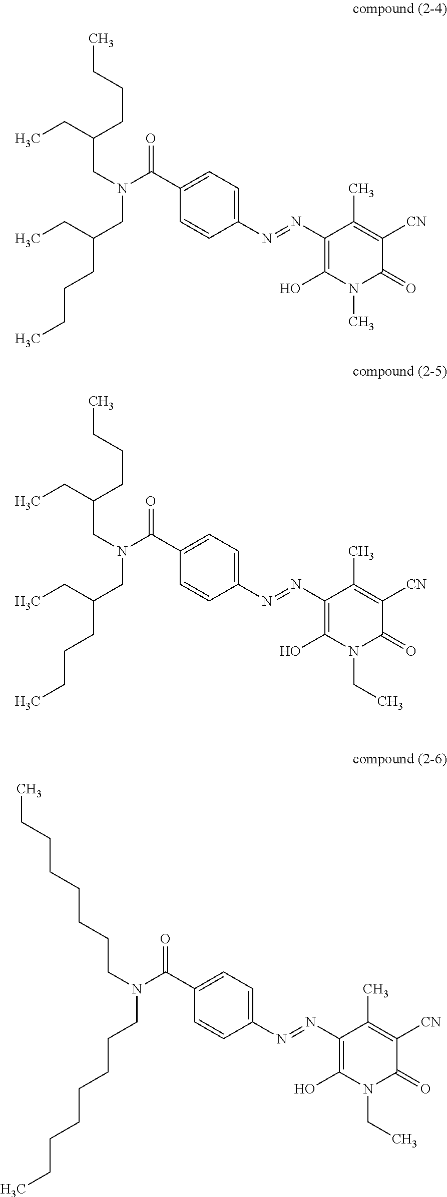 [SMILES: CCCCC(CC)CN(CC(CC)CCCC)C(=O)c1ccc(/N=N/c2c(C)c(C#N)c(=O)n(C)c2O)cc1 ; CCCCC(CC)CN(CC(CC)CCCC)C(=O)c1ccc(/N=N/c2c(C)c(C#N)c(=O)n(CC)c2O)cc1 ; CCCCCCCCN(CCCCCCCC)C(=O)c1ccc(/N=N/c2c(C)c(C#N)c(=O)n(CC)c2O)cc1]

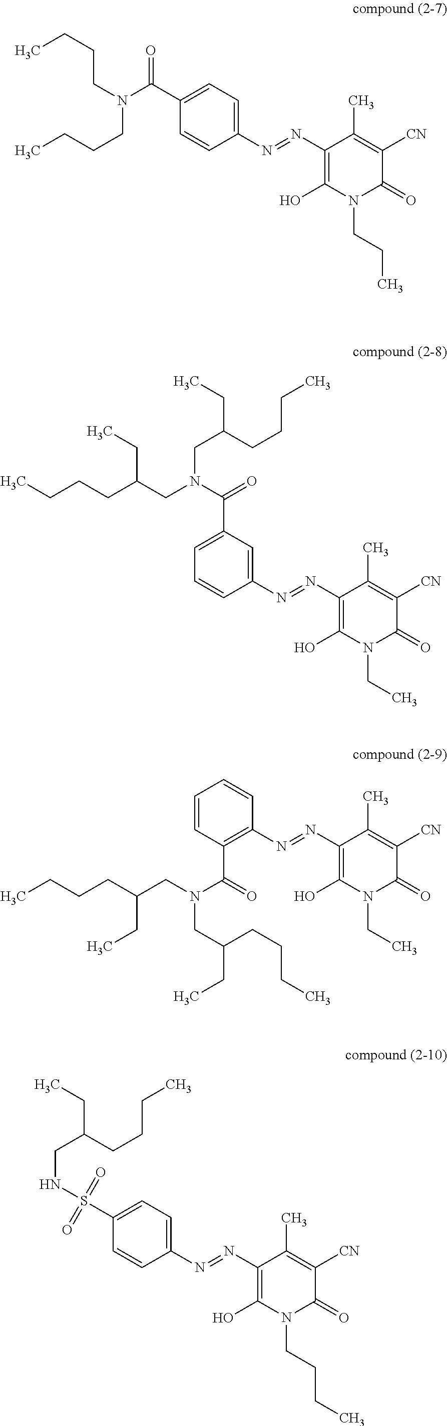 [SMILES: CCCCN(CCCC)C(=O)c1ccc(/N=N/c2c(C)c(C#N)c(=O)n(CCC)c2O)cc1 ; CCCCC(CC)CN(CC(CC)CCCC)C(=O)c1cccc(/N=N/c2c(C)c(C#N)c(=O)n(CC)c2O)c1 ; CCCCC(CC)CN(CC(CC)CCCC)C(=O)c1ccccc1/N=N/c1c(C)c(C#N)c(=O)n(CC)c1O ; CCCCC(CC)CNS(=O)(=O)c1ccc(/N=N/c2c(C)c(C#N)c(=O)n(CCCC)c2O)cc1]

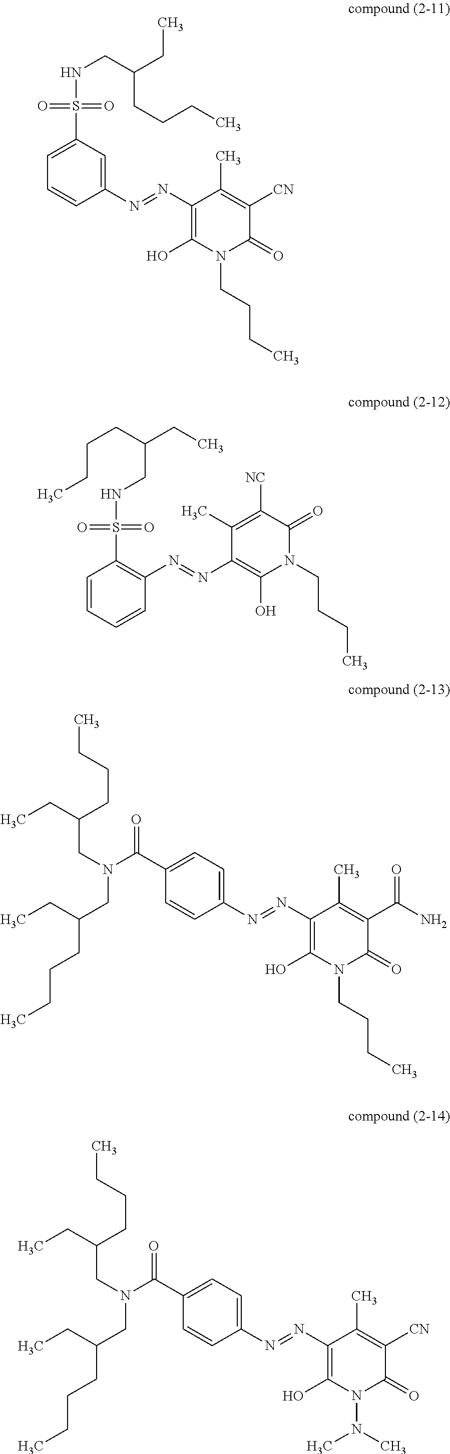

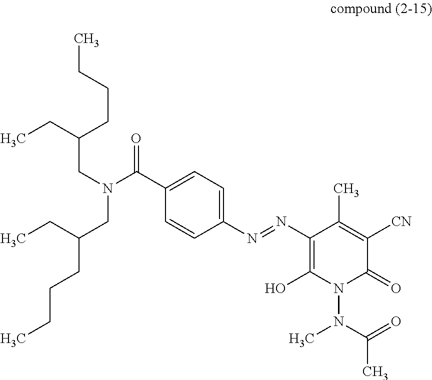 [SMILES: CCCCC(CC)CN(CC(CC)CCCC)C(=O)c1ccc(/N=N/c2c(C)c(C#N)c(=O)n(N(C)C(C)=O)c2O)cc1]

These compounds represented by formula (2) may be used alone, or two or more thereof may be used in combination in order to adjust the color tone etc., in accordance with the use. They can also be used in combination with known pigments or dyes. The known pigments or dyes used in combination may be two or more.

Among these, the compounds (2-2), (2-5), (2-6), (2-10), and (2-14) can be used because it is easy to obtain an image that is less likely to lose its color balance even when the image is stored for a long period of time.

### Formula (3)

The compound (magenta dye) represented by formula (3) will be described below:

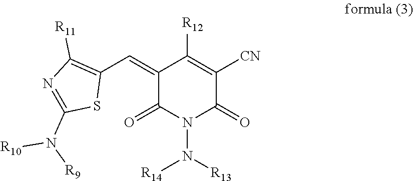

where in formula (3).
R₉ and R₁₀ are each independently an unsubstituted alkyl group or an alkyl group having a substituent,
R₁₁ is an unsubstituted alkyl group, an unsubstituted aryl group, or an aryl group having a substituent,
R₁₂ is an unsubstituted alkyl group, and
R₁₃ and R₁₄ are each independently an unsubstituted alkyl group, an alkyl group having a substituent, an unsubstituted aryl group, an aryl group having a substituent, an unsubstituted acyl group, or an acyl group having a substituent.

In formula (3), the alkyl group for each of R₉ and R₁₀ can be, but is not particularly limited to, a substituted or unsubstituted alkyl group having 1 to 20 carbon atoms. When a substituent is contained, the number of carbon atoms includes the number of carbon atoms of the substituent. Specific examples of the unsubstituted alkyl group include linear, branched, or cyclic, and saturated or unsaturated alkyl groups, such as a methyl group, an ethyl group, a n-propyl group, an isopropyl group, a n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, and a 2-ethylhexyl group. An example of a substituent in the substituted alkyl group is a cyclohexenyl group. Among these, an alkyl group having 1 to 8 carbon atoms can be used, and a branched alkyl group, such as a 2-ethylhexyl group, can be particularly used, because it is easy to obtain an image that is less likely to lose its color balance even when the image is stored for a long period of time.

Non-limiting examples of the alkyl group for R₁₁ in formula (3) include linear or branched alkyl groups each having 1 to 4 carbon atoms. Specific examples thereof include primary alkyl groups, such as a methyl group, an ethyl group, a n-propyl group, and a n-butyl group; secondary alkyl groups, such as an isopropyl group and a sec-butyl group; and tertiary alkyl groups, such as a tert-butyl group. Among these, a tertiary alkyl group, such as a tert-butyl group, can be used because it is easy to obtain an image that is less likely to lose its color balance even when the image is stored for a long period of time.

Non-limiting examples of the aryl group for R₁₁ in formula (3) include substituted or unsubstituted aryl groups each having 6 to 20 carbon atoms. Examples of a substituent include an alkyl group and an alkoxy group. When a substituent is contained, the number of carbon atoms includes the number of carbon atoms of the substituent. The number of substituents may be one or more. Specific examples of the substituted or unsubstituted aryl group having 6 to 20 carbon atoms include a phenyl group, a 4-methylphenyl group, a 2,4-dimethylphenyl group, a 2,6-dimethylphenyl group, a 3,5-dimethylphenyl group, a 2,4,6-trimethylphenyl group, a pentamethylphenyl group, a 4-methoxyphenyl group, a 2,6-dimethoxyphenyl group, a 2,4-dimethoxyphenyl group, a 3,5-dimethoxyphenyl group, a 2,4,6-trimethoxyphenyl group, and a naphthyl group. Among these, a substituted or unsubstituted phenyl group can be used, and an unsubstituted phenyl group can be particularly used, because it is easy to obtain an image that is less likely to lose its color balance even when the image is stored for a long period of time.

Non-limiting examples of the alkyl group for R₁₂ in formula (3) include linear or branched alkyl groups each having 1 to 8 carbon atoms. Specific examples thereof include a methyl group, an ethyl group, a n-propyl group, an isopropyl group, a n-butyl group, an isobutyl group, a 2-methylbutyl group, a 2,3,3-trimethylbutyl group, and an octyl group. Among these, a methyl group, an ethyl group, a propyl group, a n-butyl group, a 2-methylbutyl group, and a 2,3,3-trimethylbutyl group can be used, and a methyl group can be particularly used, because it is easy to obtain an image that is less likely to lose its color balance even when the image is stored for a long period of time.

Non-limiting examples of the alkyl group for each of R₁₃ and R₁₄ in formula (3) include substituted or unsubstituted alkyl groups each having 1 to 20 carbon atoms. When a substituent is contained, the number of carbon atoms includes the number of carbon atoms of the substituent. Specific examples of the unsubstituted alkyl group include linear, branched, or cyclic alkyl groups, such as a methyl group, an ethyl group, a n-propyl group, an isopropyl group, a n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, and a 2-ethylhexyl group. An example of a substituent in the substituted alkyl group is a cyclohexenyl group. Among these, an alkyl group having 1 to 4 carbon atoms can be used, and a methyl group can be particularly used.

Non-limiting examples of the aryl group for each of R₁₃ and R₁₄ in formula (3) include substituted or unsubstituted aryl groups each having 6 to 10 carbon atoms. Examples of a substituent include an alkyl group and an alkoxy group. When a substituent is contained, the number of carbon atoms includes the number of carbon atoms of the substituent. The number of substituents may be one or more. The substituted or unsubstituted aryl group having 6 to 10 carbon atoms can be, for example, a phenyl group, a 4-methylphenyl group, or a 4-methoxyphenyl group because it is easy to obtain an image that is less likely to lose its color balance even when the image is stored for a long period of time.

R₁₃ and R₁₄ are each an unsubstituted alkyl group, an alkyl group having a substituent, an unsubstituted aryl group, an aryl group having a substituent, an unsubstituted acyl group, or an acyl group having a substituent.

Non-limiting examples of the acyl group for each of R₁₃ and R₁₄ in formula (3) include substituted or unsubstituted acyl groups each having 1 to 30 carbon atoms. When a substituent is contained, the number of carbon atoms includes the number of carbon atoms of the substituent. Specific examples thereof include a formyl group; substituted or unsubstituted alkylcarbonyl groups each having 2 to 30 carbon atoms, such as an acetyl group, a propionyl group, and a pivaloyl group; substituted or unsubstituted arylcarbonyl groups each having 7 to 30 carbon atoms, such as a benzoyl group and a naphthoyl group: and heterocyclic carbonyl groups, such as a 2-pyridylcarbonyl group and a 2-furylcarbonyl group. Among these, an acetyl group, a pivaloyl group, or a benzoyl group can be used, and an acetyl group or a benzoyl group can be particularly used, because it is easy to obtain an image that is less likely to lose its color balance even when the image is stored for a long period of time.

A method for producing the compound represented by formula (3) according to an embodiment of the present disclosure will be described below. The compound according to an embodiment of the present disclosure can be synthesized with reference to a known method described in International Publication No. WO2014/034094. The compound represented by formula (3) includes cis-trans isomers, any of which is within the scope of the present disclosure, and the compound represented by formula (3) may be a mixture thereof.

Examples of the compound that is represented by formula (3) and that can be used are the following compounds (3-1) to (3-14), but the present disclosure is not limited thereto.

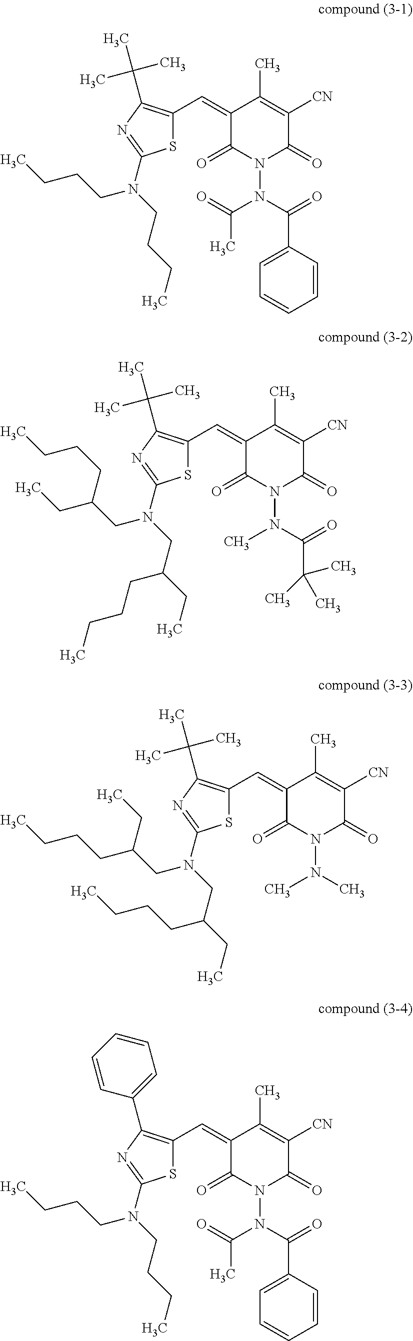

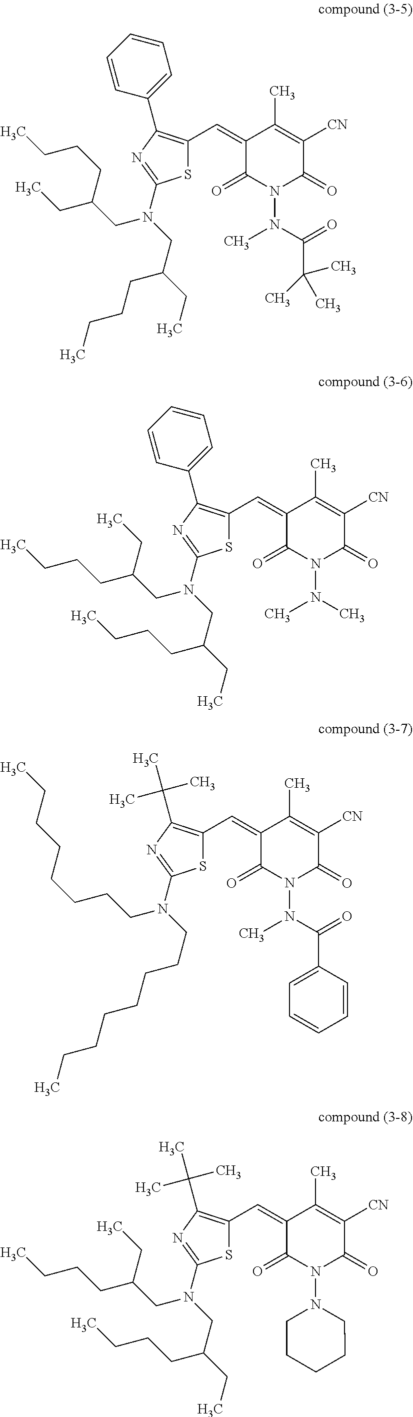

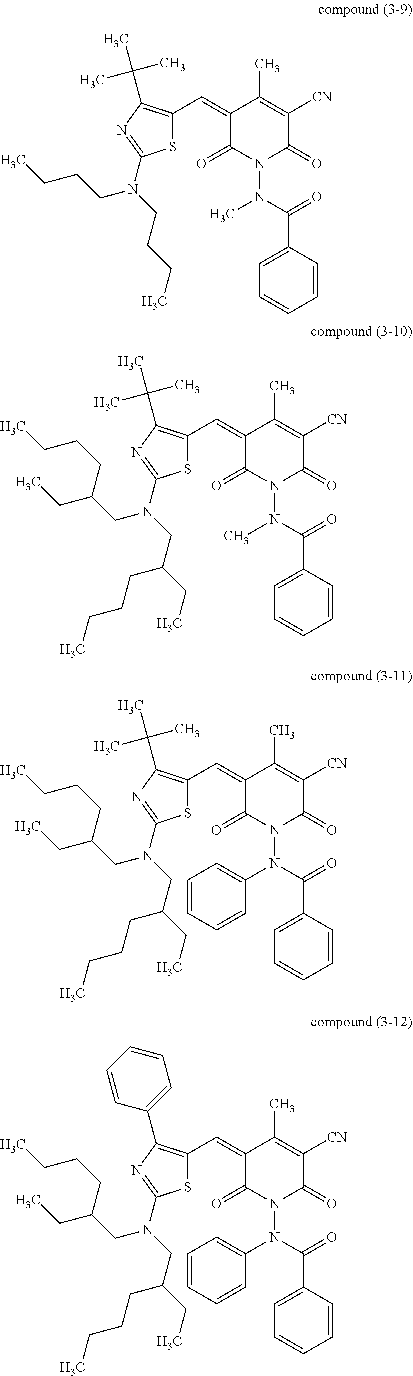 [SMILES: CCCCN(CCCC)c1nc(C(C)(C)C)c(/C=C2\C(=O)N(N(C)C(=O)c3ccccc3)C(=O)C(C#N)=C2C)s1 ; CCCCC(CC)CN(CC(CC)CCCC)c1nc(C(C)(C)C)c(/C=C2\C(=O)N(N(C)C(=O)c3ccccc3)C(=O)C(C#N)=C2C)s1 ; CCCCC(CC)CN(CC(CC)CCCC)c1nc(C(C)(C)C)c(/C=C2\C(=O)N(N(C(=O)c3ccccc3)c3ccccc3)C(=O)C(C#N)=C2C)s1 ; CCCCC(CC)CN(CC(CC)CCCC)c1nc(-c2ccccc2)c(/C=C2\C(=O)N(N(C(=O)c3ccccc3)c3ccccc3)C(=O)C(C#N)=C2C)s1]

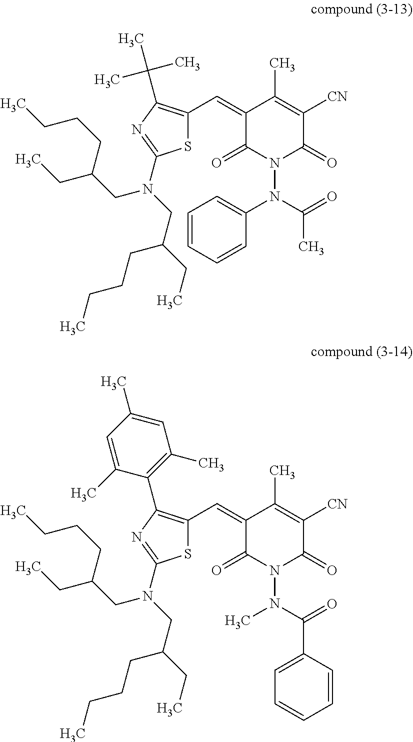 [SMILES: CCCCC(CC)CN(CC(CC)CCCC)c1nc(C(C)(C)C)c(/C=C2\C(=O)N(N(C(C)=O)c3ccccc3)C(=O)C(C#N)=C2C)s1 ; CCCCC(CC)CN(CC(CC)CCCC)c1nc(-c2c(C)cc(C)cc2C)c(/C=C2\C(=O)N(N(C)C(=O)c3ccccc3)C(=O)C(C#N)=C2C)s1]

These compounds represented by formula (3) may be used alone, or two or more thereof may be used in combination in order to adjust the color tone etc., in accordance with the use. They can also be used in combination with known pigments or dyes. The known pigments or dyes used in combination may be two or more.

Among these, the compounds (3-1), (3-2), (3-3), (3-7), and (3-10) can be used because it is easy to obtain an image that is less likely to lose its color balance even when the image is stored for a long period of time.

### Formula (4)

A compound represented by formula (4) will be described:

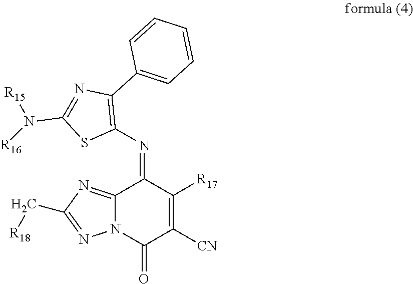

where in formula (4).
R₁₅ and R₁₆ are each independently a linear or branched alkyl group having 1 to 12 carbon atoms, R₁₇ is an alkyl group having 1 to 4 carbon atoms, and R₁₀ is a tert-butyl group, an isopropyl group, a phenyl group, or a benzyl group.

Non-limiting examples of the linear or branched alkyl groups each having 1 to 12 carbon atoms for each of R₁₅ and R₁₆ in formula (4) include a methyl group, an ethyl group, a n-propyl group, an isopropyl group, a n-butyl group, a sec-butyl group, a tert-butyl group, a n-hexyl group, a n-heptyl group, a n-octyl group, a n-nonyl group, a n-decyl group, a n-undecyl group, a n-dodecyl group, a 2-ethylhexyl group, and a cyclohexyl group.

Among these, an alkyl group having 8 carbon atoms can be used, and a branched alkyl group, such as a 2-ethylhexyl group, can be particularly used, because it is easy to obtain an image that is less likely to lose its color balance even when the image is stored for a long period of time.

Non-limiting examples of the alkyl group having 1 to 4 carbon atoms for R₁₇ in formula (4) include linear or branched alkyl groups, such as a methyl group, an ethyl group, a n-propyl group, an isopropyl group, a n-butyl group, a sec-butyl group, and a tert-butyl group. Among these, a methyl group and an ethyl group can be used.

In formula (4), R₁₈ is a tert-butyl group, an isopropyl group, a phenyl group, or a benzyl group. Among these, a tert-butyl group and a phenyl group can be used.

Examples of the compound that is represented by formula (4) and that can be used are the following compounds (4-1) to (4-7), but the present disclosure is not limited thereto.

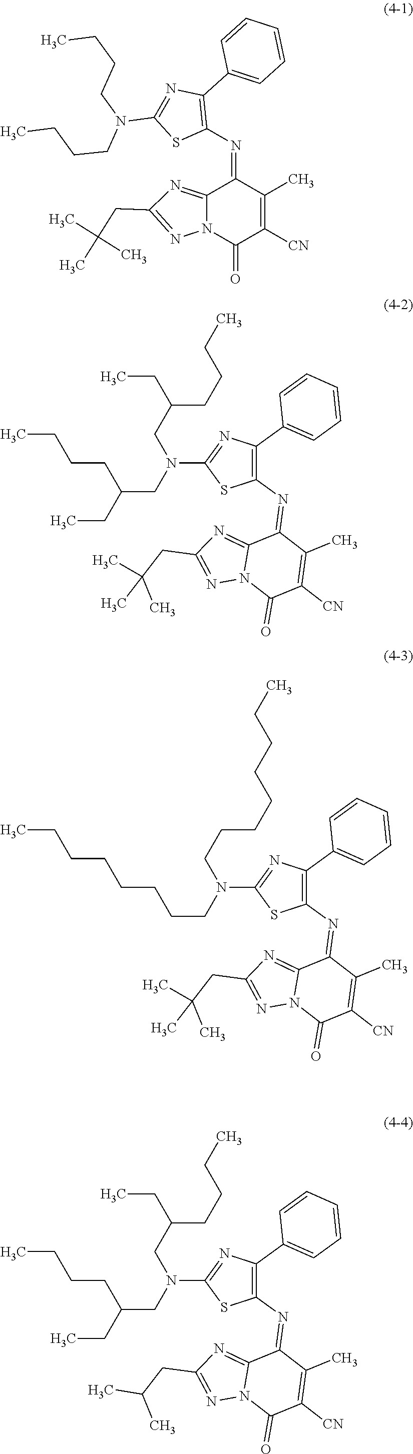

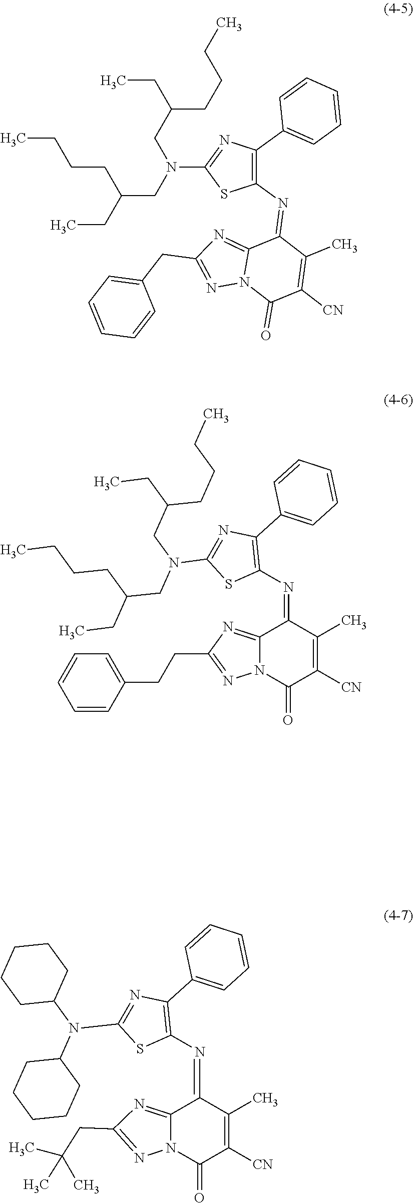 [SMILES: CCCCC(CC)CN(CC(CC)CCCC)c1nc(-c2ccccc2)c(/N=C2/C(C)=C(C#N)C(=O)n3nc(Cc4ccccc4)nc32)s1 ; CCCCC(CC)CN(CC(CC)CCCC)c1nc(-c2ccccc2)c(/N=C2/C(C)=C(C#N)C(=O)n3nc(CCc4ccccc4)nc32)s1 ; CC1=C(C#N)C(=O)n2nc(CC(C)(C)C)nc2/C1=N\c1sc(N(C2CCCCC2)C2CCCCC2)nc1-c1ccccc1]

These compounds represented by formula (4) may be used alone, or two or more thereof may be used in combination in order to adjust the color tone etc., in accordance with the use. They can also be used in combination with known pigments or dyes. The known pigments or dyes used in combination may be two or more.

Among these, the compounds (4-1), (4-2), and (4-5) can be used because it is easy to obtain an image that is less likely to lose its color balance even when the image is stored for a long period of time.

### (ii) Binder Resin

The binder resin that can be used in each coloring material layer of the thermal transfer recording sheet is not limited to a particular binder resin, and various resins can be used. Among these, the following water-soluble resins and organic solvent-soluble resins can be used.

Water-soluble resins: cellulose resins, poly(acrylic acid) resins, starch resins, epoxy resins, etc.

Organic solvent-soluble resins: polyacrylate resins, polymethacrylate resins, polystyrene resins, polycarbonate resins, poly(ether sulfone) resins, poly(vinyl butyral) resins, ethylcellulose resins, acetylcellulose resins, polyester resins, AS resins, phenoxy resins, etc.

These binder resins may be used alone, or two or more thereof may be used in combination as necessary.

(iii) Surfactant

A surfactant may be added to each coloring material layer of the thermal transfer recording sheet in order to provide sufficient lubricity during heating with a thermal head (during printing). Examples of the surfactant that can be added to each coloring material layer include cationic surfactants, anionic surfactants, and nonionic surfactants.

Examples of the cationic surfactants include dodecylammonium chloride, dodecylammonium bromide, dodecyltrimethylammonium bromide, dodecylpyridinium chloride, dodecylpyridinium bromide, and hexadecyltrimethylammonium bromide.

Examples of the anionic surfactants include fatty acid soaps, such as sodium stearate and sodium dodecanoate, sodium dodecyl sulfate, sodium dodecylbenzene sulfonate, and sodium lauryl sulfate.

Examples of the nonionic surfactants include dodecyl polyoxyethylene ether, hexadecyl polyoxyethylene ether, nonylphenyl polyoxyethylene ether, lauryl polyoxyethylene ether, sorbitan monooleate polyoxyethylene ether, and monodecanoyl sucrose.

### (iv) Wax

Wax may be added to each coloring material layer of the thermal transfer recording sheet in order to provide sufficient lubricity when the thermal head is not heated. Non-limiting examples of wax that can be added to each coloring material layer include polyethylene wax, paraffin wax, and fatty ester wax.

### (v) Other Additives

In addition to the additives described above, for example, ultraviolet absorbers, preservatives, antioxidants, antistatic agents, viscosity modifiers, may be added to each coloring material layer of the thermal transfer recording sheet, if necessary.

### (vi) Medium

Non-limiting examples of a medium that can be used for preparing each dye composition for the thermal transfer recording sheet include water and organic solvents. Examples of organic solvents that can be used include alcohols, such as methanol, ethanol, isopropanol, and isobutanol; cellosolves, such as methyl cellosolve and ethyl cellosolve; aromatic hydrocarbons, such as toluene, xylene, and chlorobenzene; esters, such as ethyl acetate and butyl acetate; ketones, such as acetone, methyl ethyl ketone, methyl isobutyl ketone, and cyclohexanone; halogenated hydrocarbons, such as methylene chloride, chloroform, and trichlorethylene; ethers, such as tetrahydrofuran and dioxane; and N,N-dimethylformamide and N-methylpyrrolidone. These organic solvents may be used alone, or two or more thereof may be used in combination, if necessary. Water and an organic solvent can also be used in combination.

### (I-3-3) Composition of Dye Composition for Forming Coloring Material Layer Dye Content (Amount Used)

The amount of each coloring material (yellow dye, magenta dye, or cyan dye) used in each dye composition is preferably 1 part or more by mass and 200 parts or less by mass in total based on 100 parts by mass of the binder resin, from the viewpoint of storage stability of the sheet. From the viewpoint of dispersing the coloring material, the amount used is more preferably 50 parts or more by mass and 180 parts or less by mass based on 100 parts by mass of the binder resin. When two or more coloring materials are mixed and used, the amount of coloring material used indicates the total amount of respective coloring materials in units of parts by mass. For example, when the compound represented by formula (2) and an existing dye are used, as a yellow dye, in combination, the amount of dye used indicates the total number of parts by mass of these dyes.

### Amount of Other Components Contained (Amount Used)

The amount of other components (additives) used can be set appropriately and is not limited to a particular amount.

### (I-4) Another Layer

### Black Coloring Material Layer

In addition to the at least three coloring material layers including a yellow coloring material layer, a magenta coloring material layer, and a cyan coloring material layer, the thermal transfer recording sheet may include a known black coloring material layer as a coloring material layer. The black coloring material layer can be formed of a composition containing a black dye or containing an existing yellow dye, an existing magenta dye, and an existing cyan dye and can contain the compound represented by any of formulae (2) to (4).

### (II) Method for Producing Thermal Transfer Recording Sheet

The thermal transfer recording sheet may be produced by any method, for example, by the following method.

A dye (coloring material) represented by one of formulae (2) to (4) corresponding to the color of the target coloring material layer, and optionally a binder resin, a surfactant, and a wax are gradually added to and sufficiently mixed with a medium (for example, an organic solvent) under stirring.

Stable dissolution or fine dispersion of these components in the medium under mechanical shear force with a dispersing apparatus produces a dye composition (ink). The dye composition can be applied to a base film serving as a substrate and dried to form a target coloring material layer.

The dispersing apparatus used to prepare the dye compositions may be, but is not limited to, a media dispersing apparatus, such as a rotational shear homogenizer, a ball mill, a sand mill, or an attritor, or a high-pressure counter collision dispersing apparatus.

The thermal transfer recording sheet includes coloring material layers frame-sequentially arranged on a substrate. For example, a yellow coloring material layer, a magenta coloring material layer, a cyan coloring material layer, and a protective layer can be repeatedly formed on a substrate (substrate sheet) in the substrate movement direction. In the case of using a thermal transfer recording sheet including the coloring material layers in this order, a yellow image is first formed, then a magenta image is formed, and a cyan image is then formed. The successive image formation produces one full-color image. Finally a protective layer is formed. This successive image formation is repeatedly performed. The thermal transfer recording sheet may further include a coloring material layer other than these coloring material layers, for example, a black coloring material layer (a thermofusible black layer), over the substrate.

Each coloring material layer can be formed by applying the corresponding layer composition (dye composition) to the substrate and drying the composition. Each layer composition may be applied to the substrate by any method, for example, by using a bar coater, a gravure coater, a reverse roll coater, a rod coater, or an air doctor coater. The thickness can be easily adjusted by a coating method using a gravure coater.

The drying conditions after the application of each layer composition may be any conditions under which the layer composition can be thoroughly dried, for example, at 50° C. to 120° C. for 1 second to 5 minutes.

Thoroughly drying each dye composition can facilitate the prevention of scumming, the setoff of dye ink during winding, and retransfer of the setoff dye ink to a coloring material layer with a different hue during rewinding.

The amount of dye composition applied can be such that the thickness after drying the coloring material layer ranges from 0.1 μm to 5 μm, from the perspective of transferability.

### (III) Method for Using Thermal Transfer Recording Sheet

A thermal transfer recording sheet is placed on a member to be transferred, for example, a receiver sheet having a coloring material receiving layer on its surface and is heated, for example, with a thermal head to transfer coloring materials from the thermal transfer recording sheet to the receiver sheet, thereby forming an image. When a first thermal transfer recording sheet has the transferable protective layer, a sheet of this protective layer portion is placed on an image formed on the receiver sheet and is heated, for example, with a thermal head to transfer (form) the protective layer onto the image.

A heating unit for heating a thermal transfer recording sheet for printing is not particularly limited and may utilize infrared light or a laser beam as well as a common thermal head. Using an electric heating film, which generates heat by supplying electricity to a base film substrate, a thermal transfer recording sheet may also be used as an electric dye transfer sheet.

### EXAMPLES

While the present disclosure will be described in more detail with reference to examples and comparative examples, the present disclosure is not limited to these examples. Unless otherwise specified, the term “part(s)” is based on mass.

### Compounds Represented by Formulae (1) to (4)

The compound represented by formula (1) used for the protective layer is available from Tokyo Chemical Industry Co., Ltd., for example. Compounds represented by formulae (2) to (4) used in the coloring material layers were synthesized by known methods. Compounds were identified with a 1H nuclear magnetic resonance spectrometer (1H-NMR) (AVANCE-600 NMR spectrometer, available from BRUKER) and a MALDI-TOF/MS (MALDI-TOF/MS ultraFleXtreme, available from BRUKER).

### Comparative Compound

Comparative compounds (1) and (2) below were provided as comparative compounds for use in the protective layer.

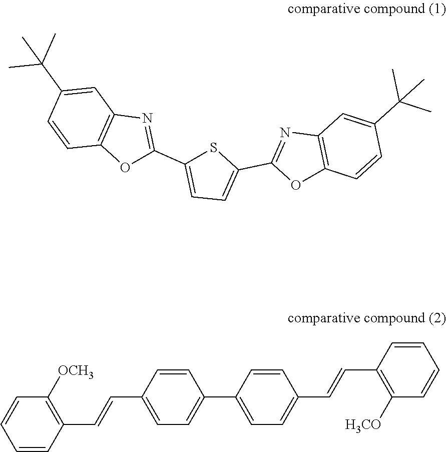 [SMILES: CC(C)(C)c1ccc2oc(-c3ccc(-c4nc5cc(C(C)(C)C)ccc5o4)s3)nc2c1 ; COc1ccccc1/C=C/c1ccc(-c2ccc(/C=C/c3ccccc3OC)cc2)cc1]

### Example 1

### Production Example 1 of Protective Layer Sheet

A release layer coating liquid 1 having the following composition was applied by a gravure coating method to the non-coated surface of a substrate including the heat-resistant slipping layer to a thickness after drying of 1.0 μm, and dried at 100° C. for 1 minute, thereby forming a release layer.

An adhesive layer coating solution 1 having the following composition was applied onto the release layer by a gravure coating method to a thickness after drying of 1.0 μm, and dried at 100° C. for 1 minute, thereby forming a protective layer sheet.

### Release Layer Coating Solution 1

Methacrylic resin (Dianal BR-83, Tg: 105° C., available from Mitsubishi Chemical Corporation) 5 parts
Polyester (Vylon 200, available from Toyobo Co., Ltd) 5 parts
Anhydrous silica (average particle size: 2 μm) 0.5 parts
Toluene 45 parts
Methyl ethyl ketone 45 parts
Adhesive Layer Coating Liquid 1
Vinyl chloride-vinyl acetate copolymer (Solbin CNL, Tg: 76, molecular weight: 16,000,
Nissin Chemical Industry Co., Ltd.) 100 parts
Compound (1-1) 5 parts
Tinuvin 329 (available from BASF) 25 parts
Methyl ethyl ketone 870 parts

### Preparation Example 1 of Dye Composition

Five parts of a poly(vinyl butyral) resin (trade name: KS-3, available from Sekisui Chemical Co., Ltd.) was added little by little to and dissolved in a mixed solution of 45 parts of methyl ethyl ketone and 45 parts of toluene. Five parts of compound (2-5) was added to this solution and dissolved completely to prepare a dye composition for a yellow coloring material layer.

A dye composition for a magenta coloring material layer was prepared in the same manner, except that compound (2-5) was changed to compound (3-10). A dye composition for a cyan coloring material layer was prepared in the same manner, except that compound (2-5) was changed to compound (4-5).

### Production Example 1 of Thermal Transfer Recording Sheet

A poly(ethylene terephthalate) film (trade name: Lumirror, available from Toray Industries, Inc.) having a thickness of 4.5 μm was provided as a substrate. Using each dye composition and the protective layer sheet prepared above, a yellow coloring material layer, a magenta coloring material layer, a cyan coloring material layer, and a protective layer were formed in a frame-sequential manner on the prepared substrate so as to have a thickness of 1 μm after drying, thereby producing a thermal transfer recording sheet.

### Examples 2 to 11 and Comparative Examples 1 to 3

Thermal transfer recording sheets according to Examples 2 to I1 and Comparative examples 1 to 3 were produced as in Example 1, except that the compounds used in adhesive layer coating liquid 1 of Production Example 1 of Protective Layer Sheet and the compounds used in Preparation Example 1 of Dye Composition were changed to those given in Table 1.

### Comparative Example 4

A dye composition for a yellow coloring material layer was prepared as in Preparation Example 1 of Dye Compositions, except that 1.25 parts of compound (1-1) was added to compound (2-5). A dye composition for a magenta coloring material layer was prepared in the same manner, except that compound (2-5) was changed to compound (3-10) and 1.25 parts of compound (1-1) was added. A dye composition of a cyan coloring material layer was prepared in the same manner, except that compound (2-5) was changed to compound (4-5) and 1.25 parts of compound (1-1) was added.

Subsequently, a thermal transfer recording sheet according to Comparative example 4 (an example in which the compound represented by formula (1) was contained in each coloring material layer) was produced as in Comparative example 3, except that these dye compositions were used.

### Preparation and Evaluation of Image Sample

Using the resulting thermal transfer recording sheets according to Examples 1 to 11 and Comparative examples 1 to 4, single-color images were transferred to printing paper with a modified machine of Selphy (trade name) available from CANON KABUSHIKI KAISHA (the heat quantity supplied for thermal transfer was reduced to about 80%) to produce image samples.

The color of each of the image samples was measured with a reflection densitometer FD-7 (trade name, manufactured by Konica Minolta, Inc.).

The color balance of each image sample was evaluated in the following manner. The evaluation was performed by an exposure test for a predetermined time in order to clarify that the color balance was not easily lost even when the image was stored for a long period of time.

### Evaluation of Color Balance

Each of the single-color image samples obtained in Examples 1 to 11 and Comparative examples 1 to 4 was placed in a xenon test apparatus (trade name: Atlas Ci4000, available from Suga Test Instruments Co., Ltd.), and exposed for 20 hours and 35 hours at an illuminance of 0.28 W/m² at 340 nm, a temperature of 40° C., and a relative humidity of 50%.

When the initial optical density (O.D.) was defined as OD₀ and the O.D. after h hours of exposure was defined as ODₕ, the O.D. residual rate was defined by the following formula.

O.D. residual rate=100×(ODₕ/OD₀)

According to this equation, the absolute value of the difference in the O.D. residual rate of each color at each exposure time was calculated.
Difference in residual O.D. between magenta dye and yellow dye (difference in residual O.D. of MY dyes)
Difference in residual O.D. between magenta dye and cyan dye (difference in residual O.D. of MC dyes)
Difference in residual O.D. between yellow dye and cyan dye (difference in residual O.D. of YC dyes)

Difference in residual O.D. of MY dyes=|(O.D. residual rate of magenta−O.D. residual rate of yellow)|

Difference in residual O.D. of MC dyes=|(O.D. residual rate of magenta−O.D. residual rate of cyan)|

Difference in residual O.D. of YC dyes=|(O.D. residual rate of yellow−O.D. residual rate of cyan)|

Variations (X) in color balance are calculated based on the maximum value and the minimum value in the difference in residual O.D. of the MY dyes, the difference in residual O.D. of the MC dyes, and the difference in residual O.D. of the YC dyes:

Variations (X) in color balance=maximum value−minimum value.

The variations (X) in color balance calculated from the above equation were evaluated based on the following evaluation criteria. These values and their evaluation results are given in Table 1 below.
A (very good color balance): (X)<0.10
B (good color balance): 0.10≤(X)≤0.20
C (poor color balance): 0.20<(X)

TABLE 1

| | | Yellow | Magenta | Cyan | | Difference | Difference | Difference | Variations | Evalua- |
|---|---|---|---|---|---|---|---|---|---|---|
| | Protective | coloring | coloring | coloring | Exposure | in residual | in residual | in residual | in color | tion |
| | layer | material layer | material layer | material layer | time | O.D. of | O.D. of | O.D. of | balance | of color |
| | Formula (1) | Formula (2) | Formula (3) | Formula (4) | (h) | MY dyes | MC dyes | YC dyes | (X) | balance |
| Example 1 | (1-1) | (2-5) | (3-10) | (4-5) | 20 | 0.17 | 0.12 | 0.10 | 0.07 | A |
| | | | | | 35 | 0.23 | 0.21 | 0.18 | 0.05 | A |
| Example 2 | (1-4) | (2-10) | (3-2 | (4-2) | 20 | 0.18 | 0.19 | 0.25 | 0.07 | A |
| | | | | | 35 | 0.22 | 029 | 0.30 | 0.08 | A |
| Example 3 | (1-5) | (2-10) | (3-1 | (4-1) | 20 | 0.19 | 0.19 | 0.28 | 0.09 | A |
| | | | | | 35 | 0.27 | 0.29 | 0.35 | 0.08 | A |
| Example 4 | (1-6) | (2-6) | (3-7) | (4-5) | 20 | 0.16 | 0.14 | 0.12 | 0.04 | A |
| | | | | | 35 | 0.24 | 0.25 | 0.21 | 0.04 | A |
| Example 5 | (1-9) | (2-5) | (3-10) | (4-5) | 20 | 0.18 | 0.13 | 0.12 | 0.06 | A |
| | | | | | 35 | 0.25 | 0.22 | 0.19 | 0.06 | A |
| Example 6 | (1-10) | (2-10) | (3-3 | (4-2) | 20 | 0.19 | 0.14 | 0.13 | 0.06 | A |
| | | | | | 35 | 0.27 | 0.25 | 0.20 | 0.07 | A |
| Example 7 | (1-11) | (2-5) | (3-10) | (4-5) | 20 | 0.17 | 0.13 | 0.11 | 0.06 | A |
| | | | | | 35 | 0.24 | 0.21 | 0.19 | 0.05 | A |
| Example 8 | (1-7) | (2-5) | (3-1) | (4-5) | 20 | 0.19 | 0.15 | 0.12 | 0.07 | A |
| | | | | | 35 | 0.26 | 0.23 | 0.19 | 0.07 | A |
| Example 9 | (1-8) | (2-14) | (3-10) | (4-5) | 20 | 0.18 | 0.12 | 0.11 | 0.07 | A |
| | | | | | 35 | 0.24 | 0.21 | 0.19 | 0.05 | A |
| Example 10 | (1-1) | (2-10) | (3-1) | (4-2) | 20 | 0.17 | 0.21 | 0.26 | 0.09 | A |
| | | | | | 35 | 0.21 | 0.31 | 0.29 | 0.10 | B |
| Example 11 | (1-1) | (2-2) | (3-3 | (4-1) | 20 | 0.21 | 0.16 | 0.15 | 0.06 | A |
| | | | | | 35 | 0.29 | 0.27 | 0.22 | 0.07 | A |
| Comparative | Comparative | (2-5) | (3-10) | (4-5) | 20 | 0.19 | 0.32 | 0.13 | 0.19 | B |
| example 1 | compound (1) | | | | 35 | 0.25 | 0.43 | 0.18 | 0.25 | C |
| Comparative | Comparative | (2-10) | (3-2) | (4-2) | 20 | 0.23 | 0.35 | 0.15 | 0.20 | B |
| example 2 | compound (2) | | | | 35 | 0.32 | 0.45 | 0.19 | 0.26 | C |
| Comparative | not added | (2-5) | (3-10) | (4-5) | 20 | 0.22 | 0.02 | 0.21 | 0.20 | B |
| example 3 | | | | | 35 | 0.30 | 0.03 | 0.26 | 0.27 | C |
| Comparative | not added | (2-5) | (1-1) contained | (1-1) contained | 20 | 0.29 | 0.03 | 0.26 | 0.26 | C |
| example 4 | | (1-1) contained | (3-10) | (4-5) | 35 | 0.43 | 0.07 | 0.36 | 0.36 | C |

As is clear from Table 1, the images of the image samples formed using the thermal transfer recording sheets described in Examples are less likely to lose color balance even when the images are stored for a long period of time.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-115657 filed Jul. 20, 2022 and No. 2023-076113 filed May 2, 2023, which are hereby incorporated by reference herein in their entirety.

What is claimed is:

1. A thermal transfer recording sheet, comprising:
a substrate;
a yellow coloring material layer;
a magenta coloring material layer;
a cyan coloring material layer; and
a protective layer,
wherein the yellow coloring material layer, the magenta coloring material layer, the cyan coloring material layer, and the protective layer are frame-sequentially arranged over the substrate, and
the protective layer contains a compound represented by formula (1): 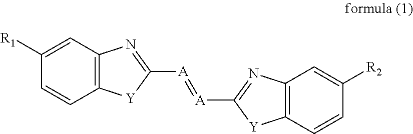
where in formula (1),
each A is independently ═CH— or ═CH—C₆H₄—,
each Y is independently an oxygen atom or a sulfur atom, and
R₁ and R₂ are each independently a hydrogen atom or an alkyl group having 1 to 4 carbon atoms.

2. The thermal transfer recording sheet according to claim 1, wherein each A is ═CH— in formula (1).

3. The thermal transfer recording sheet according to claim 1, wherein each Y is an oxygen atom in formula (1).

4. The thermal transfer recording sheet according to claim 1, wherein the yellow coloring material layer contains, as a yellow dye, at least one compound selected from compounds represented by the following formula (2),
the magenta coloring material layer contains, as a magenta dye, at least one compound selected from compounds represented by the following formula (3), and
the cyan coloring material layer contains, as a cyan dye, at least one compound selected from compounds represented by the following formula (4): 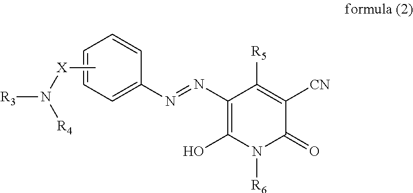
where in formula (2),
X is a carbonyl group or a sulfonyl group,
R₃ and R₄ are each independently a linear alkyl group having 1 to 12 carbon atoms, a branched alkyl group having 3 to 12 carbon atoms, or a cycloalkyl group having 3 to 12 carbon atoms,
R₅ is a linear or branched alkyl group having 1 to 12 carbon atoms,
R₆ is a hydrogen atom, an alkyl group, an aryl group, a benzyl group, or —NR₇R₈, and
R₇ and R₈ are each independently a hydrogen atom, an unsubstituted alkyl group, an alkyl group having a substituent, an unsubstituted aryl group, an aryl group having a substituent, an unsubstituted acyl group, or an acyl group having a substituent, or R₇ and R₈ are optionally taken together to form a ring structure, 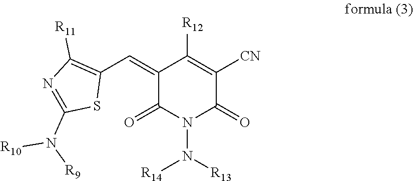
where in formula (3),
R₉ and R₁₀ are each independently an unsubstituted alkyl group or an alkyl group having a substituent,
R₁₁ is an unsubstituted alkyl group, an unsubstituted aryl group, or an aryl group having a substituent,
R₁₂ is an unsubstituted alkyl group,
R₁₃ and R₁₄ are each independently an unsubstituted alkyl group, an alkyl group having a substituent, an unsubstituted aryl group, an aryl group having a substituent, an unsubstituted acyl group, or an acyl group having a substituent, and 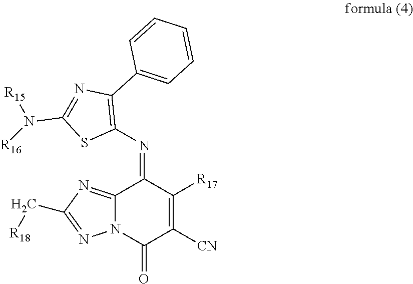
where in formula (4),
R₁₅ and R₁₆ are each independently a linear or branched alkyl group having 1 to 12 carbon atoms,
R₁₇ is an alkyl group having 1 to 4 carbon atoms, and
R₁₈ is a tert-butyl group, an isopropyl group, a phenyl group, or a benzyl group.
